(19) United States
(12) Patent Application Publication
(10) Pub. No.: US 2025/0156707 A1
(43) Pub. Date: May 15, 2025

(54) PERSONALIZED MACHINE LEARNING ON MOBILE COMPUTING DEVICES

(71) Applicant: The Board of Trustees of the Leland Stanford Junior University, Stanford, CA (US)

(72) Inventors: William San-Hsi Hwang, Seattle, WA (US); Shan Xiang Wang, Portola Valley, CA (US)

(21) Appl. No.: 18/838,192

(22) PCT Filed: Feb. 15, 2023
(86) PCT No.: PCT/US2023/062669

§ 371 Date: Aug. 13, 2024

Related U.S. Application Data
(60) Provisional application No. 63/310,529, filed on Feb. 15, 2022.

(51) Int. Cl. G06N 3/08

(52) U.S. Cl. CPC G06N 3/08

(57) ABSTRACT

In some implementations, there is provided a process for personalized learning. In some aspects, there is provided receiving, by a user equipment, a configuration for a machine learning model, the configuration comprising a plurality of weights determined by a server during a first phase training of the machine learning model; initiating, by the user equipment, a second phase of training of the machine learning model using local training data at the user equipment to personalize the machine learning model without updating the plurality of weights of the machine learning model, and triggering, by the user equipment, a third phase of training of the machine learning model using at least the local training data at the user equipment to update the plurality of weights of the machine learning model and to further personalize the machine learning model to the user of the user equipment.

### CROSS-REFERENCE TO RELATED APPLICATIONS

This application claims priority to U.S. Provisional Application No. 63/310,529 filed Feb. 15, 2022, entitled “PERSONALIZED MACHINE LEARNING ON MOBILE COMPUTING DEVICES”. The disclosure of which is incorporated herein by reference in its entirety.

### TECHNICAL FIELD

This application relates generally to machine learning.

### BACKGROUND

As artificial intelligence (AI) including machine learning (ML) models enable transformative new user experiences in mobile computing devices, data security and privacy has become increasingly important. In a mobile deployment scenario, the ML model can be trained in a remote, cloud-based server with a large training data set and can then be deployed to mobile devices. While this approach is generalizable to some mobile device users, this does not provide user personalization, so certain users can experience subpar performance. Moreover, a given user may be hesitant (e.g., out of a concern for data security and privacy) to personalize the training of an ML model hosted on the cloud-based server.

### SUMMARY

Systems, methods, and articles of manufacture, including computer program products, are provided for personalized machine learning.

In one aspect, there is provided a method that includes receiving, by a user equipment, a configuration for a machine learning model, the configuration comprising a plurality of weights determined by a server during a first phase training of the machine learning model; initiating, by the user equipment, a second phase of training of the machine learning model using local training data at the user equipment to personalize the machine learning model to a user of the user equipment without updating the plurality of weights of the machine learning model, wherein the local training data is applied to the machine learning model to generate at least a reference embedding mapped to a label, wherein the reference embedding and the label are stored in a dictionary at the user equipment; in response to receiving a first unknown sample at the machine learning model, using, by the user equipment, the machine learning model to perform a first inference task by generating a first embedding that is used to query the dictionary to find at least the first reference embedding and the label that identifies the first unknown sample; in response to a condition at the user equipment being satisfied, triggering, by the user equipment, a third phase of training of the machine learning model using at least the local training data at the user equipment to update the plurality of weights of the machine learning model and to further personalize the machine learning model to the user of the user equipment; and in response to receiving a second unknown sample at the machine learning model, using, by the user equipment, the machine learning model with the updated weights to perform a second inference task by generating a second embedding to query the dictionary to find a second reference embedding and a corresponding label that identifies the second unknown sample.

In some variations, one or more of the features disclosed herein including the following features can optionally be included in any feasible combination. In response to the update of the plurality of weights of the machine learning model, the reference embeddings are updated. The receiving may further include receiving an initial set of one or more reference embedding mapped to corresponding labels. The machine learning model receives inputs from different domains, wherein the different domains include at least one of the following: audio samples, video samples, image samples, biometric samples, bioelectrical samples, electrocardiogram samples, electroencephalogram samples, and/or electromyogram samples. The dictionary comprises an associative memory contained in the user equipment, wherein the associative memory stores a plurality of reference embeddings, each of which is mapped to a label. The associative memory comprises a lookup table, content-addressable memory, and/or a hashing function implemented memory, and/or wherein the associative memory comprises a random access memory coupled to digital circuitry that searches the random access memory for a reference embedding. The dictionary is comprised in magnetoresistive memory using spin orbit torque and/or spin transfer torque. The first unknown sample and the second unknown sample comprise speech samples from at least one speaker, wherein the first unknown sample and the second unknown sample comprise image samples, and/or wherein the first unknown sample and the second unknown sample comprise video samples. The first unknown sample and the second unknown sample comprise biometric samples, wherein the biometric samples comprise an electrocardiogram sample, an electroencephalogram sample, and/or an electromyogram signals. The at least one reference embedding, the first embedding, and the second embedding each comprise a feature vector generated as an output of the machine learning model. The machine learning model comprises a neural network and/or a convolutional neural network. The machine learning model is trained using a triplet loss function and/or gradient descent. At least one layer of the machine learning model uses the same weights when processing inputs from different domains.

Implementations of the current subject matter can include systems and methods consistent with the descriptions provided herein as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to personalized machine learning, it should be readily understood that such features are not intended to be limiting. The claims that follow this disclosure are intended to define the scope of the protected subject matter.

### DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1A depicts an example of a system including a machine learning model, in accordance with some embodiments;

FIG. 1B depicts an example of a rapid personalization process, in accordance with some embodiments;

FIG. 1C depicts another example depiction of a system including a machine learning model, in accordance with some embodiments;

FIGS. 2A and 2B depict examples of layers of machine learning model being shared across different input domains, in accordance with some embodiments;

FIG. 3 depicts using a triplet loss function across one or more domains, in accordance with some embodiments;

FIGS. 4A-4B depict an example of a machine learning model in a multimode (or domain) configuration, in accordance with some embodiments;

FIG. 5 depicts a schematic representation of a hybrid spin transfer torque-assisted spin orbit torque memory device, in accordance with some embodiments;

FIG. 6 depicts a schematic representation of an n-bit hybrid spin orbit torque spin transfer torque memory device, in accordance with some embodiments;

FIG. 7 depicts an example of a process, in accordance with some embodiment; and

FIG. 8 depicts an example system, in accordance with some embodiments.

### DETAILED DESCRIPTION

In some embodiments, there is provided a way to deploy an ML model to an edge mobile device (herein referred to as a user equipment (UE)), such that the ML model can be quickly used by the end user, while allowing for rapid personalization and fine-grained personalization.

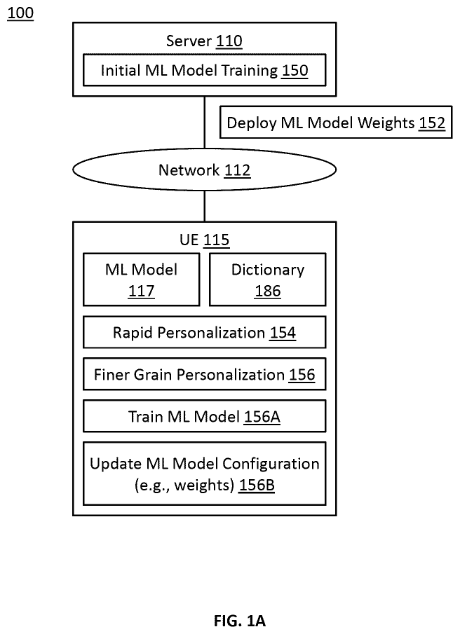

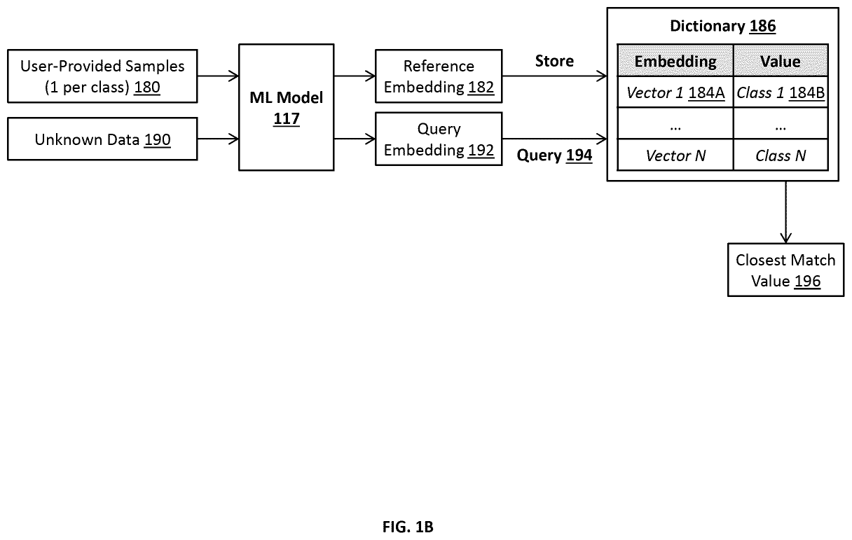

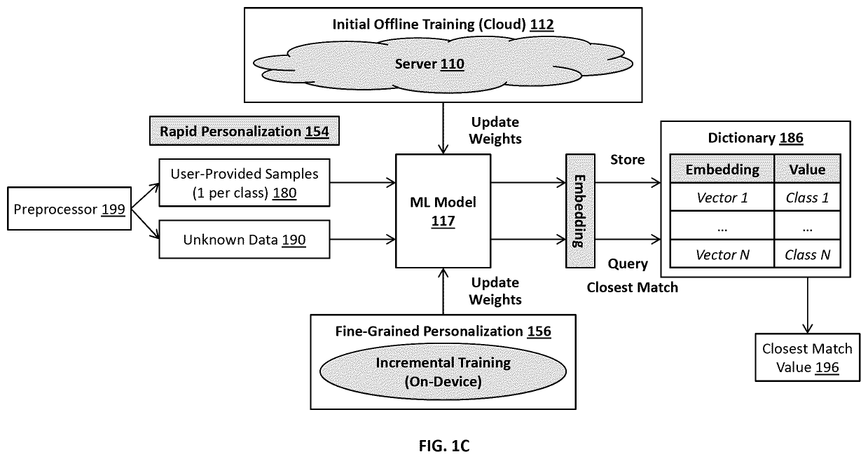

FIG. 1A depicts an example of a system 100, in accordance with some embodiments. The system may include a server 110, such as a cloud-based server or other type of server as well. The server may couple to one or more UEs, such as UE 115, via a network 112, such as a cellular wireless network (or other type of wireless and/or wired network). The UE may be implemented as a mobile wireless device, such a smartphone, a cell phone, a tablet, an Internet of Things (IoT) device, and/or other type of processor and memory device with at least a wireless interface to the network 112.

Although FIG. 1A depicts a simple example of a single server 110, network 112, and UE 115 for ease of explanation, other quantities of these devices may be implemented as well in system 100.

In some embodiments, the server 110 may be used to initially train, at 150, an ML model, such as a neural network, convolutional neural network (CNN), or other type of ML model to perform a ML learning task, such as recognize speech, classify an image, detect a condition in a biometric signal, and/or other task. The training may include supervised (or semi-supervised) learning using a “training” data set (e.g., a labeled or semi-labeled dataset), although the training may also include unsupervised learning as well.

When the server 110 trains an ML model, the server may, at 152, deploy via a network 112 the ML model 117 to one or more UEs, such as the UE 115 (e.g., smart phone, tablet, cell phone, IoT device, and/or the like), in accordance with some embodiments. The server may deploy the ML model 117 by sending to the UE the ML model configuration (e.g., at least the weights and/or other parameters of the ML model to enable execution at the UE 115). Unlike a mobile edge device such as the UE, the server has greater processing, storage, memory, network, and/or other resources, so the server can train the ML model using a training data set that is larger and/or more robust than the UE. However, the server's ML model training is not personalized to a specific end user of the UE, but rather trained generally to allow the ML model to be deployed across a broad base of end users accessing UEs.

When the ML model 117 is deployed to the UE 115, the UE may use the ML model 117 without personalization. But this will result in an ML model that is not personalized to the end user. In the case of speech for example, the ML model is not trained using the user's local data (which may be private data, personal data, and/or data specific to the user), such that the ML model is personalized to the specific speech patterns of the user. In accordance with some embodiments, a rapid personalization process 154 may be initiated or triggered at the UE 115. For example, the UE 115 (or ML model 117) may cause a rapid personalization process to be implemented at the UE in order to provide some personalization of the ML model.

The ML model 117 may convert one or more input samples into an embedding (e.g., a n-dimensional vector). The input samples may correspond to signals (e.g., speech, audio, images, video, biometric, and/or other types of modes or domains of signals). And, in some embodiments, the input samples may be preprocessed into the intermediate representation of the input sample/signal. For example, in the case of speech, the speech samples may be preprocessed into a spectrogram. The ML model may be implemented using at least one neural network, at least one convolutional neural network (CNN), and/or using other types of ML model technology. In some embodiments, the ML model is sized for use within the resource constraints of the mobile edge device, such as UE 115. For example, the number of layers, number of weights, and the like may be configured at the ML model to allow use within the limited resource constraints of the UE. For example, the ML model 117 may be configured to have fewer weights, when compared to an ML model hosted on a device that is not as resource limited as the UE 115. In other words, the ML model is sized according to the computational and memory resources available on the mobile computing device such as the UE 115.

FIG. 1B depicts an example of the rapid personalization process where the user provides at 180 an input sample, such as a word or group of words, as an input to the ML model 117, which then outputs at 182 an embedding (e.g., output vector) that is stored at 184A in a dictionary 186. This “reference embedding” is stored with a label or value at 184B. The user may provide at 180 an additional sample, such as an additional word or an additional grouping of words, as another input to the ML model 117, which is then output at 182 as an embedding that is stored in the dictionary 186. An embedding is an n-dimensional vector that represents the input sample (or, e.g., signal). In the example of FIG. 1B, there are a plurality (e.g., “N”) of embeddings or vectors stored in the dictionary. This dictionary 186 is thus used to provide a relatively rapid way to personalize the user's experience at the UE including the ML model without having to re-train and update the weights to the ML model (which requires more resources when compared to the rapid personalization of the dictionary). When an unknown input sample or signal (e.g., word or phrase) is provided at 190 to the ML model 117, the ML model 117 outputs an embedding 192. At 194, this embedding is then used to query the dictionary 186, such that the closest, matching embedding in the dictionary is identified and output at 196. To illustrate with an example, the vector 1 may map to a value of “red dog” (Class 1) while vector N maps to a value of “Cleveland” (Class N). In this example, when the unknown data input 190 corresponds to “red”, “dog”, “red dog”, or even “red cat”, the ML model provides the corresponding embedding used to query the dictionary, which returns in this example a closest match of class 1 “red dog.”

In some embodiments, the dictionary 186 (also referred to as a codebook or encoder) may be used to convert, as noted, the n-dimensional vector-representation of the signal (e.g., the embedding) generated by the ML model 117 to a matching output value, such as a label. By way of another example, the dictionary receives as an input an embedding (which is generated by the ML model 117 for the corresponding “Unknown Data”) and returns at 196 a value (or label) mapped to (or associated with) the closest matching embedding in dictionary 186. In other words, if Vector 1 is the matching Embedding for the query 194, the mapped Class 1 label (or value) is output at 196.

In some embodiments, the dictionary 186 may comprise an associative memory. The associative memory may include a lookup table, content-addressable memory, hashing function, and the like, such that given a query for an embedding at 194, the associative memory identifies an output at 196. The content-addressable memory may be implemented with memory technology, such as dynamic random access memory (DRAM), Flash memory, static random access memory (SRAM), spin transfer torque (STT)-assisted spin orbit torque (SOT)-magnetoresistive random access memory (MRAM) (SAS-MRAM), resistive RAM (RRAM), FeFET RAM, phase change memory (PCM), and/or other types in memory. To illustrate further, the dictionary 186 may be implemented with memory attached to a hardware accelerator, which comprises digital circuitry to compute the similarity (e.g., cosine similarity, L2 distance, and/or other similarity measure) between the unknown embedding input at 194 and the reference embeddings stored inside the dictionary in order to find the best match (e.g., closest within a threshold distance or exact) at 196. As such, the dictionary may be implemented with a content-addressable memory or random access memories.

Referring again to FIG. 1A, the UE 115 may be continued to be used with the rapid personalization 154. At some point in time, additional personalization (which is referred to herein as a finer grained personalization 156) may be desired. At 156, the UE 115 may trigger a finer grained personalization (e.g., given certain resource conditions at the UE or at a request of the user of the UE). The finer grained personalization includes additional training of the ML model 117 using input samples (or signals) of the user of the UE, such as the user's speech in the case of audio/voice, user's face in the case of images, the user's biometric signals, and/or the like. This finer grained personalization retrains the ML model and thus updates the weights of the ML model.

As this finer grained personalization requires greater resources of the UE (when compared to the rapid personalization), the finer grained personalization may be triggered by certain conditions at the UE. For example, the conditions may include one or more of the following: detecting the UE is plugged in or charging; detecting the UE is coupled to a wireless local area network rather than cellular network; detecting the UE resource utilization (e.g., processor, memory, network bandwidth, power, and/or the like) is below a given threshold (or thresholds), such as at when the UE is not being used; detecting the UE is asleep or in idle; detecting a time of day (e.g., nighttime); and/or other conditions where the UE can accommodate training the ML model without impact user experience or operation of the UE. Moreover, the condition may be a default condition, a condition provided by the user of the UE, and/or a condition provided by the cloud server.

To perform the finer grained personalization at 156, the UE 115 hosting the ML model 117 may initiate, at 156A, a training phase of the ML model 115. For example, the UE may provide to the ML model a training data set of one or more words (or phrases) uttered by the user during the day(s) (e.g., after the rapid personalization phase) and stored (e.g., an audio signal and corresponding label indicative of the audio sample). Referring to the example above, the word “red dog” as well as other input data samples obtained by the UE may be used as part of the training set. The UE may use input data samples obtained from other sources as part of the training set. The other sources may include o the cloud, devices on the local network (wired or wireless), other UEs on the local network, and/or the like. Using the training set, the ML model may converge (e.g., using gradient descent) to another configuration of weights. These weights may then be used as the updated weights of the ML model. The dictionary 186 may be updated using the updated weights of the ML model 117 following the rapid personalization 154 procedure. In other words, the rapid personalization 154 provides some personalization of the ML model, but the finer grained personalization provides additional personalization of the ML model.

Although the previous example refers to the ML model 117 operating in a single mode, such as audio (e.g., word, phrase, speech, or speaker recognition mode), other, different types of modes (also referred to as domains) may be used as well, such as images, video, biometric data (e.g., EKG data, heartrate, etc.) and/or the like. Moreover, the ML model 117 may comprise an ensemble of a plurality of ML models. Furthermore, the ML model(s) may be multimodal, which refers to the ML model(s) being able to train and infer across different modes of input samples, such as speech, images, biometric data, and/or the like.

FIG. 1C depicts another representation of the systems and processes at FIGS. 1A-1B. FIG. 1C includes a preprocessor 199. For example, the preprocessor may be used to process a raw signal (e.g., a raw audio signal from a microphone or a stored audio signal) into a format that is compatible with the input of the ML model 117. For example, the preprocessor may convert the raw signal or sample (which may be received from a sensor, such as a microphone, heart rate sensor, EKG sensor, camera, or other type of sensor) to a format that is compatible with the input of the ML model. In the case of a ML model which receives as input different types of multimode (also referred to as multi-domain) signals or samples, the preprocessor may convert the input to another, intermediate representation that can be handled by the ML model. For example, the intermediate format (or representation) may be common or compatible with some (if not all) of the multimode input data/sample types and thus can be passed to the ML model. To illustrate further, the intermediate representation may be a 3-dimensional tensor with dimensions of a certain width, height, and depth, although other types of intermediate representations may be used as well. The preprocessing may also include padding (e.g., zero padding) or clipping to provide compatibility/matching with respect to the structure of size of the intermediate representations across the different modes. As noted, the preprocessor 199 may be used to preprocess so called raw input samples or signals, so the input can be handled by the ML model 117. In the case of preprocessing audio signals, raw audio signals may be encoded with the signal amplitude on the y-axis and time on the x-axis. Next, the raw audio signal may be converted into its intermediate representation (e.g., a 3-dimensional tensor) by calculating its spectrogram, with the frequency on the y-axis (e.g., the height-axis of the 3-dimensional tensor) and time on the x-axis (e.g., the width-axis of the 3-dimensional tensor). Moreover, the spectrogram can be calculated using a short-time Fourier transform (STFT) with a window size and stride of for example 30 milliseconds and 10 milliseconds, respectively, with the frequency bins rescaled using mel-frequency cepstral coefficients, although the spectrogram may be generated in other ways as well. For audio signals with multiple channels (e.g., stereo audio), a spectrogram for each channel may be calculated and the spectrograms would be stacked in the depth-dimension of the 3-dimensional tensor. For example, the depth dimension would be two for stereo audio, one for mono audio, six for 5.1 surround sound audio, and the like. In the case of the preprocessor 199 preprocessing images, the images are 3-dimensional tensors, with the two spatial dimensions on the width and height axes of the 3-dimensional tensor, and the color channels on the depth-axis. The preprocessing may perform down sampling of the image along the width and height dimensions to convert the image into its intermediate representation. In the case of the input corresponding to bioelectrical signals (e.g., electrocardiogram (EKG) signals electroencephalogram, electromyogram, or other types of biometric signals), the time-varying bioelectrical signals can be preprocessed in a manner similar to the audio signals or image signals depending on the frequency and sampling rate of the bioelectrical signals or other factors. For example, bioelectrical signals having a relatively higher frequency and sample rates may be processed as noted above with respect to the audio signals, while bioelectrical signals at lower frequencies and sampling rates may be processed as noted with respect to the images (although the bioelectric signals may be preprocessed in other ways as well). For bioelectrical signals with multiple input channels, each channel would be represented along the depth-axis of the 3-dimensional tensor, in the same manner as an image with multiple color channels or an audio signal with multiple channels.

In some embodiments, the UE 115 and/or the ML model 117 may be configured to support at least one mode of input samples, such as audio (e.g., speech), images, biometric data, and/or the like.

In some embodiments, the UE 115 and/or the ML model 117 may be configured for three phases of learning.

In some embodiments, the first phase of learning is the initial learning 150 of the server 110, which is then deployed (e.g., by sending weights) to the UE 115 including the ML model 117. For example, the first phase of training may be offline training at the server 110 with a relatively large training data set. Alternatively, or additionally, the server 110 may, as part of the first phase deployment of weights at 152, provide an initial set of reference embeddings for the dictionary 186.

In some embodiments, the second phase of learning is the rapid personalization 154 on the UE 115. In the rapid personalization phase, the ML model 117 weights are not updated. Rather than re-train the ML model and update the weights to provide learning, the user may provide examples or samples (e.g., an example per class) to update the reference embeddings in the dictionary 186. As noted, an embedding may be an n-dimensional vector (e.g., a 1 by 16 vector, a 2 by 2 vector, a 3 by 3 vector or matrix, etc.) that represents the input sample, such as the speech, image, biometric data, and/or other type of input signal or sample. For example, if the user of the UE 115 wishes to update the reference dictionary with personalized embeddings for the spoken word “cat”, the ML model generates as an output an embedding for the spoken word “cat” and the embedding is then stored in the dictionary (see, e.g., “Embedding” column of dictionary 186 at FIG. 1B) with its corresponding Value “cat” (see, e.g., “Value” in column of dictionary 186 at FIG. 1B). Likewise, if the user of the UE 115 wishes to update the reference dictionary with personalized embeddings for the spoken word “dog”, the ML model generates as an output an embedding for the spoken word “dog” and the embedding is then mapped with its label or value “dog” and stored in the dictionary with its corresponding value or label (e.g., the value of dog). This process may be repeated for the N embeddings and their mapped values in the dictionary. The personalization of the dictionary may be triggered by the user of the UE 115 (e.g., the user selects what samples to personalize in the dictionary). Alternatively, or additionally, the personalization of the dictionary may be triggered by the UE 115 (e.g., the UE prompts the user to provide specific samples by repeating certain samples, such as words or phrases).

The third phase of learning is the finer grain personalization 156, which is performed on the device, such as UE 115. The finer grain personalization may comprise one or more incremental training sessions of the ML model. In other words, finer grain personalization may occur from time to time to personalize the ML model. An incremental training session may occur when the resource utilization of the UE or ML model is below a threshold utilization. For example, when the UE or ML model are idle (e.g., the UE is not being used, at night when plugged in and charging, etc.), the ML model may be retrained to update the weights of the ML model. To retrain the ML model, samples collected from the user by the UE over time (e.g., throughout the day) may be used to perform the incremental training when the device is idle (e.g., plugged in and charging at night). This incremental training provides updated ML model weights, so that the ML model can be tailored to the specific user of the UE, which thus personalizes the ML model to the specific user.

To illustrate an example implementation of the ML model 117, the ML model may comprise a neural network such as a convolutional neural network. In this example, the CNN includes two convolutional layers, one pooling layer (which performs downsampling), and one fully connected layer, although other configurations of the CNN may be implemented. Assuming the input tensor to the CNN (e.g., the intermediate representation of the input signal or sample) having height by width by depth dimensions of 98 by 40 by 1, the CNN's first layer is a convolutional layer having 64 filters, wherein each filter has dimensions of 20 by 8 by 1. The number of weights in this first layer is about 10,000 and the output of the first layer has dimensions of 98 by 40 by 64. The CNN's second layer is a max pool layer with stride 2, but this second layer does not have any weights and the output size is 49 by 20 by 64. The CNN's third layer is another convolutional layer that has 64 filters, where each filter has dimensions 10 by 4 by 64. The number of weights in this third layer is about 164,000 and the output size is 49 by 20 by 64. The CNN's fourth layer is a fully connected layer that has a weight matrix size of about 63,000 by 12, so the number of weights is about 753,000 and the output size is a vector with size 12. The total number of weights in this CNN is about one million, which can readily be stored in the memory of a UE, such as a smart phone and the like.

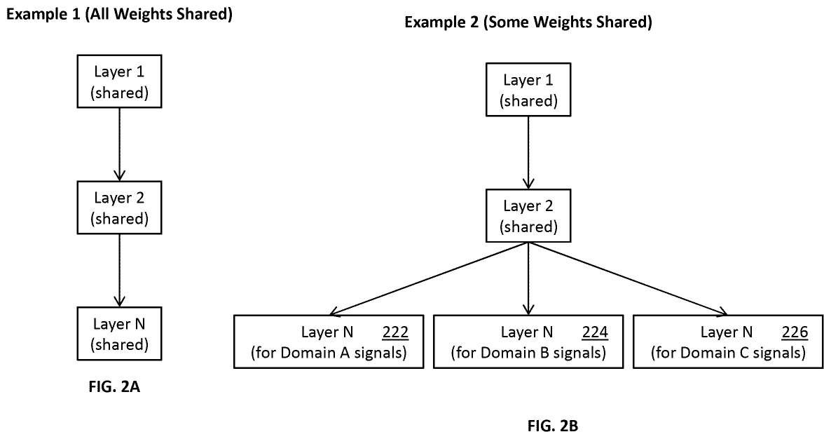

In some embodiments, the ML model 117 may be configured to handle multimode input signals. In other words, the ML model may receive at the input different types of signals or samples, such as audio, images, video, biometric data, and/or the like. When this is the case, the ML model may be structured as depicted at FIG. 2A. In the example of FIG. 2A, all of the weights of the ML model are shared across all of the multimode input samples. For example, the ML model weights are used across the different (i.e., multimode) input signals. In other words, the ML model is configured with the same weights regardless of whether the input signal is audio, image, bioelectric, and/or the like.

FIG. 2B depicts an example of the ML model 117 structure where a portion of the weights are shared. In the example of FIG. 2B, the weights from the first two layers of the ML model may be shared, so the multimode input is processed by the first and second layers. But at the final layer, a separate set of weights are used for each of the different, multimode input signals, wherein the proper set of weights is selected based upon the signal's input source when the activations pass from layer 2 to the last layer N. If the source of the input signal is audio from a microphone for example, the set of weights corresponding to the audio mode (or domain) will be selected at 222. If the source of the input signal is an image from a camera, the set of weights corresponding to the image mode (or domain) will be selected at 224. And if the source of the input signal is biometric data, the set of weights corresponding to the biometric mode (or domain) will be selected at 226. Although the example of FIG. 2B notes the use of separate weights at last layer, other layers may use separate (rather than shared) weights across the domains.

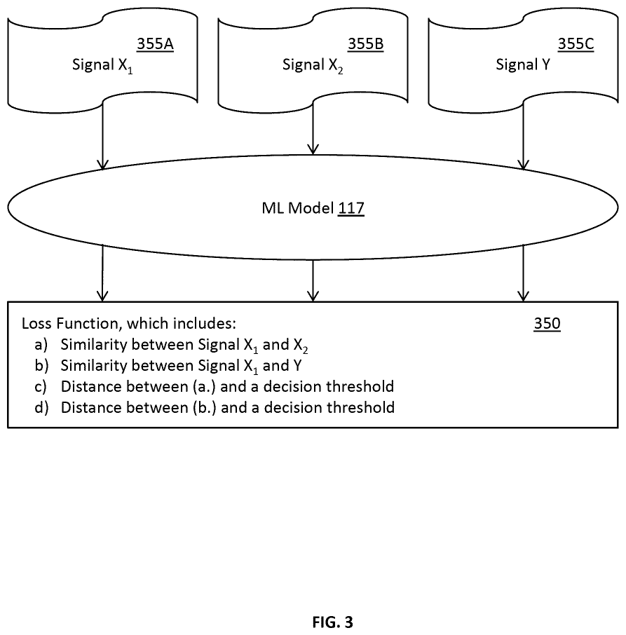

With respect to training the ML model 117 (which may be implemented as a neural network, CNN, and/or the like) to produce a n-dimensional embedding, such that similar input signals (e.g., input signals with the same label) have similar n-dimensional embeddings (e.g., similarity determined via high cosine similarity, low L2 distance, or any other method of measuring similarity between two vectors or matrices) and dissimilar input signals (e.g., input signals with different labels) have dissimilar n-dimensional vector representations (e.g., low cosine similarity, high L2 distance, or any other technique of measuring similarity between two vectors or matrices), a loss function, such as a triplet loss function, may be used. FIG. 3 depicts an example of using triplet loss function 350 across one or more modes (or domains), where 355A/B and 355C may be from the same mode (or domain) or different modes (or domains). To compute the loss function at 350, three input signals 355A-C are provided to the ML model 117, wherein input signal X1 355A and input signal X2 355B have the same label and input signal Y 355C has a different label. The loss function is calculated based upon two elements: (a) the similarity between input signals X1 and X2 with respect to a decision threshold such that a high similarity between input signals X1 and X2 results in a low loss value, and (b) the similarity between input signals X1 and Y with respect to a decision threshold such that a high similarity between input signals X1 and Y results in a high loss value. As a result, when the loss function is minimized using for example stochastic gradient descent, the weights in the ML model will be updated such that signals with the same label will have similar n-dimensional vector representations, and signals with different labels will have dissimilar n-dimensional vector representations.

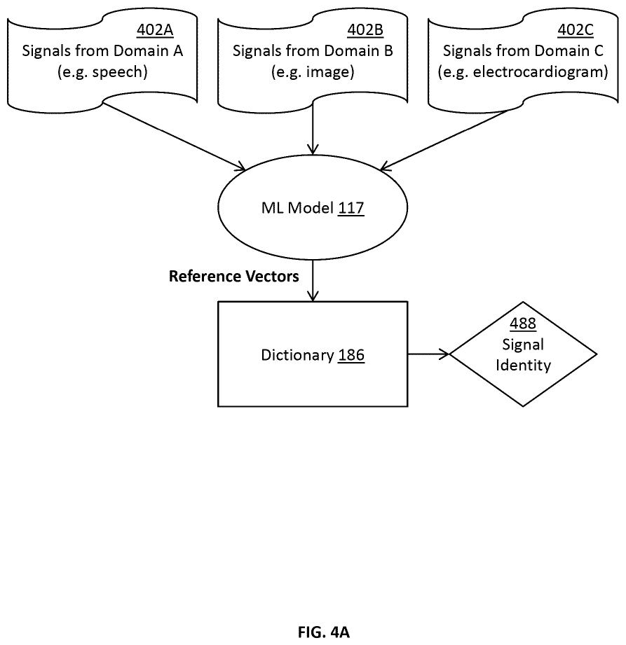

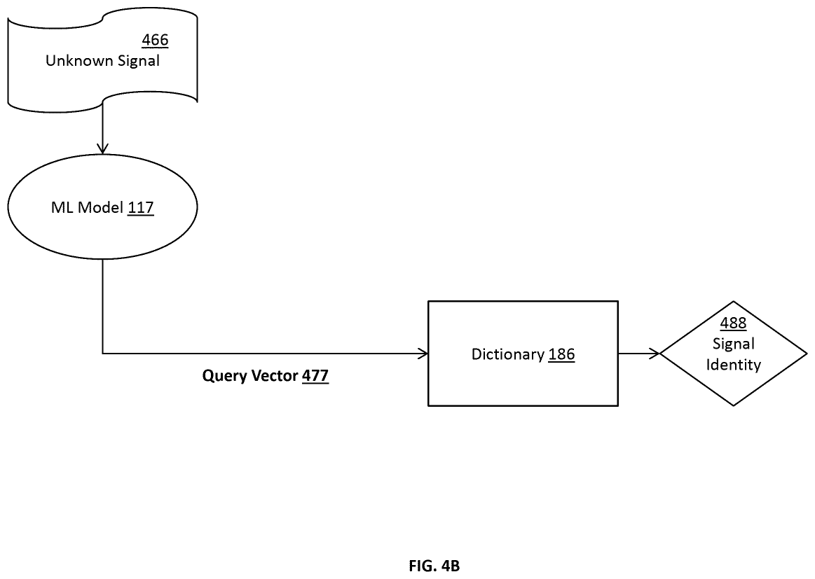

FIG. 4A depicts an example ML model 117 (which in this example is implemented as a neural network) in a multimode configuration. During the training phase of the ML model 117, the ML model is tasked to identify the spoken word “wakeup” 402A, an image of a melanoma 402B, and an irregular heartbeat 402C. The so-called raw speech 402A, image 402B, and biometric 402C (e.g., EKG) data may be preprocessed as noted above into an intermediate representation. In the case of audio 402A, the preprocessor may convert the audio to a spectrogram, with frequency bins on one axis and temporal bins on the other axis, convert the image 402B into an RGB format, with two spatial dimensions and three color channels, and convert the biometric 402C EKG data into a plot with electrocardiogram signal amplitude on one axis and time on the other axis. The ML model 117 (labeled “neural network”) may then encode each input signal as an n-dimensional embedding, where similar input signals are represented by similar n-dimensional embeddings and dissimilar input signals are represented by dissimilar n-dimensional embeddings. The “reference” embeddings (e.g., embeddings with a known label or value) and the corresponding labels are stored in the dictionary 186. During ML model inference phase when an unknown signal 466 (e.g., a sample, data sample, signal sample, etc.) is provided as an input to the ML model 117 as shown at FIG. 4B, the ML model generates an embedding as an output, and this embedding can be used to query 477 the dictionary 186. The dictionary 186 identifies which of the reference embeddings (which are stored in the dictionary during the learning phase) are an exact or a close match based on a similarity metric and are similar to the unknown signal embedding in the query 477. When there is a match, the dictionary provides an output at 488. For example, if the unknown input 466 is “wakeup” the identified output would correspond to “wakeup” at 488.

In some embodiments, spin-orbit-torque (SOT) memories may be implemented in the dictionary 186. Optimization at the hardware level provides additional opportunities to optimize the energy-efficiency. SOT memories utilizes an electric current flowing through the high efficiency SOT material to generate a spin torque which can switch the adjacent magnetic free layer such as CoFeB. The switching direction can be in the in-plane orientation (e.g. type-x or type-y) or in the perpendicular orientation (e.g. type-z) depending on the magnetic anisotropy of the device. For certain desirable switching modes (e.g. type-x or type-z), additional design considerations (e.g. an external magnetic field, canting axis, etc.) are required to enable deterministic switching. Such additional design considerations can increase fabrication complexity and adversely affect device performance. Although some of the examples refer to using SOT-based memories, other memory technologies may be used as well.

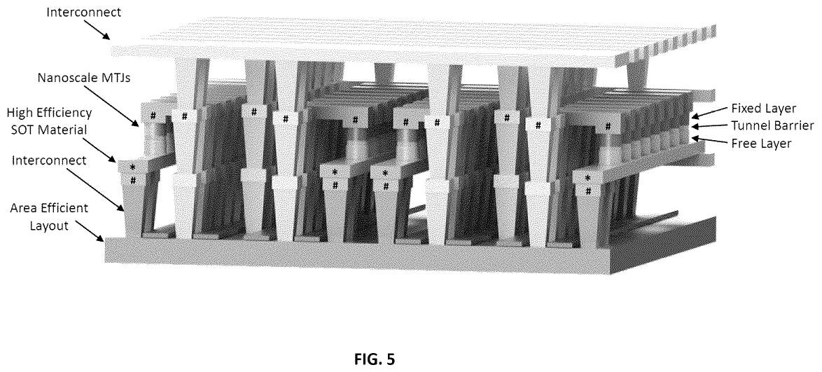

FIG. 5 shows one example of a schematic representation which depicts a hybrid STT-assisted SOT device (e.g. with 8 magnetic tunnel junctions, MTJs, sharing the same SOT layer). The SOT layer (which is indicated by the “*” at FIG. 5) and the metal interconnect stack as shown. Conventional 3-terminal SOT-MRAM can leverage a 2TIMTJ bit cell architecture in its nominal embodiment. Two transistors are necessary in order to control the currents that pass through the SOT layer and MTJ stack independently, though certain bit cell architectures forego one transistor in order to improve bit cell density (at the expense of independent current control). Conventional SOT switching can require a bidirectional switching current; thus, it is often difficult to drive the SOT layer with a single, minimum-width transistor. In certain situations, the SOT driver may be about 6 times larger than a minimum-width transistor. Compared to SRAM, conventional 3-terminal SOT-MRAM can enable roughly about 2 to 3 times bit cell density improvement. The bit cell density can be further improved by adjusting the layout of the bit cell in tandem to adopting a hybrid switching approach (e.g., SOT assisted by STT) as shown in FIG. 5, leading to a roughly greater than 2 times bit cell density improvement compared to conventional 3-terminal SOT MRAM while maintaining the desirable switching speed characteristics of 3-terminal SOT-MRAM. In a hybrid STT-assisted SOT device, the SOT layer is shared between multiple MTJs, reducing the average layout area of each MTJ compared to conventional 3-terminal SOT devices. In such a bit cell architecture, the current that passes through the SOT layer is shared between all MTJs on the string and the current that passes through each MTJ can be controlled independently through the MTJ's top electrode. In certain hybrid STT-assisted SOT devices, a unidirectional SOT current is sufficient to switch the MTJs, thus allowing for a more area-efficient SOT drive transistor.

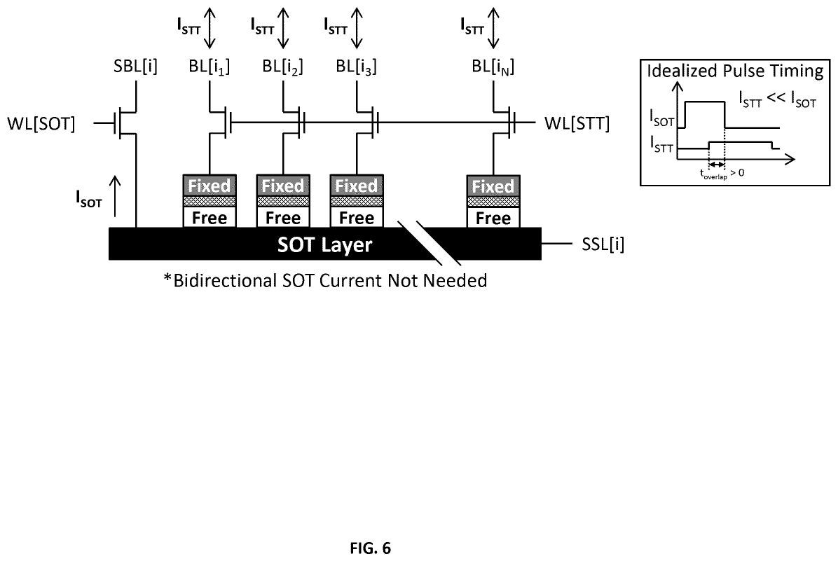

In some embodiments, there is provided a hybrid STT-assisted SOT device, writing can be performed in a single step and does not require a bidirectional SOT current. FIG. 6 depicts a schematic representation of an n-bit hybrid SOT+STT device, where the inset shows the idealized pulse timing. A unidirectional SOT current pulse is used to neutralize the state of the device and a small STT current is used to break the symmetry and enable deterministic field-free switching. In the first phase of writing, a strong current pulse, that is sufficient to overcome the anisotropy of the device, is applied to the SOT layer. The strong SOT torque effectively neutralizes the state of the device such that the free layer of the MTJ is suspended midway between the parallel (e.g. ‘1’) and the antiparallel (e.g. ‘0’) states. In the second phase of writing, we apply a small STT current to each bitline and release the SOT current pulse, such that the STT torque is sufficient to deterministically break the symmetry between the parallel and antiparallel state. As a result, each bit will relax to its desired magnetic state. Moreover, there is provided an example of a transistor layout of the bit cell architecture using conventional Manhattan routing rules and note that our proposed bit cell architecture can be readily tiled in an area-efficient manner with approximately three metal layers.

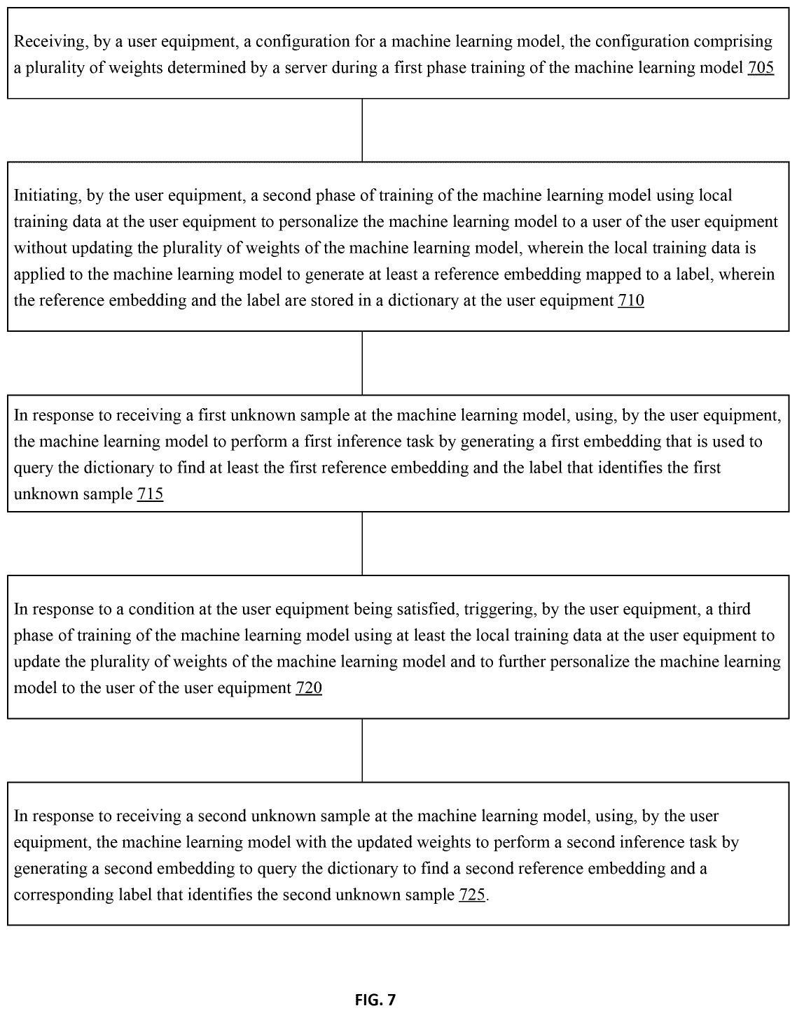

FIG. 7 depicts an example of a process for ML model personalization, in accordance with the subject matter disclosed here.

At 705, the UE 115 may receive a configuration for a machine learning model 117 from the server 110. The configuration may include a plurality of weights determined by a server during a first phase training of the machine learning model. The receiving may also include receiving an initial set of one or more reference embedding mapped to corresponding labels. This initial set of reference embedding enables the ML model 117 and reference dictionary 186 to be used before the second phase training that personalizes to the user of the user equipment.

At 710, the UE 115 may initiate a second phase of training of the machine learning model 117 using local training data at the user equipment to personalize the machine learning model to a user of the user equipment without updating the plurality of weights of the machine learning model. The local training data may be applied to the machine learning model to generate at least a reference embedding mapped to a label (e.g., the Vectors 1 . . . Vector N, each of which is mapped to a value, such as Class 1 . . . Class N). The reference embedding and the label are stored in a dictionary, such as dictionary 186, at the user equipment.

At 715, in response to receiving a first unknown sample at the machine learning model, the UE 115 uses the machine learning model 117 to perform a first inference task by generating a first embedding that is used to query the dictionary to find at least the first reference embedding and the label that identifies the first unknown sample. For example, when an unknown sample is received at 180, the ML model 117 performs an inference task, such as speech recognition, image classification, biometric classification, etc. The ML model generates an embedding 192 which is used to query 194 the dictionary 186 for a matching value 196.

At 720, in response to a condition at the user equipment being satisfied, the user equipment triggers a third phase of training of the machine learning model using at least the local training data at the user equipment to update the plurality of weights of the machine learning model and to further personalize the machine learning model to the user of the user equipment. The condition include one or more of the following: detecting the UE is plugged in or charging; detecting the UE is coupled to a wireless local area network rather than cellular network; detecting the UE resource utilization (e.g., processor, memory, network bandwidth, power, and/or the like) is below a given threshold (or thresholds), such as at when the UE is not being used; detecting the UE is asleep or in idle; and detecting a time of day (e.g., nighttime). When the condition is detected, the UE proceeds with the a third phase of training of the machine learning model using local training data to update the plurality of weights of the machine learning model. This additional training personalizes the machine learning model to the user of the user equipment.

At 725, in response to receiving a second unknown sample at the machine learning model, the UE uses the machine learning model with the updated weights to perform a second inference task by generating a second embedding to query the dictionary to find a second reference embedding and a corresponding label that identifies the second unknown sample. For example, when another unknown sample is received at 180, the ML model 117 performs an inference task, such as speech recognition, image classification, biometric classification, etc. The ML model generates an embedding 192 which is used to query 194 the dictionary 186 for a matching value 196.

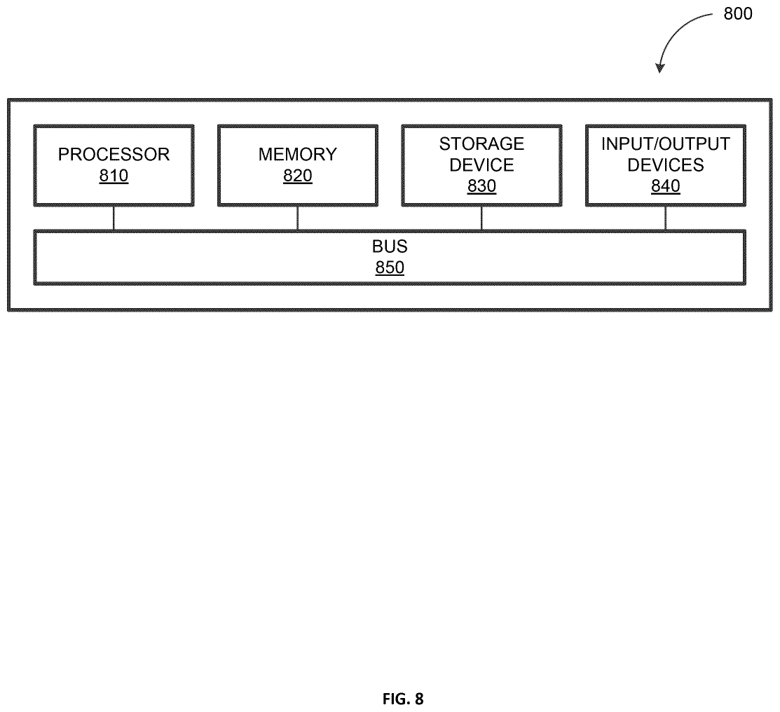

FIG. 8 depicts a block diagram illustrating a system 800 consistent with implementations of the current subject matter. The computing system 800 can be used to implement the ML model and/or other aspects noted herein including aspects of the UE. As shown in FIG. 8, the system 800 can include a processor 810, a memory 820, a storage device 830, and input/output devices 840. The processor 810, the memory 820, the storage device 830, and the input/output devices 840 can be interconnected via a system bus 850. The processor 810 is capable of processing instructions for execution within the computing system 800. In some implementations of the current subject matter, the processor 810 can be a single-threaded processor. Alternately, the processor 810 can be a multi-threaded processor. Alternately, or additionally, the processor 810 can be a multi-processor core, AI chip, graphics processor unit (GPU), neural network processor, and/or the like. The processor 810 is capable of processing instructions stored in the memory 820 and/or on the storage device 830 to display graphical information for a user interface provided via the input/output device 840. The memory 820 is a computer readable medium, such as volatile or non-volatile memory, that stores information within the computing system 800. The memory 820 can store data structures representing configuration object databases, for example. The storage device 830 is capable of providing persistent storage for the computing system 800. The storage device 830 can be a solid-state device, a floppy disk device, a hard disk device, an optical disk device, a tape device, and/or any other suitable persistent storage means. The input/output device 840 provides input/output operations for the computing system 800. In some implementations of the current subject matter, the input/output device 840 includes a keyboard and/or pointing device. In various implementations, the input/output device 840 includes a display unit for displaying graphical user interfaces. According to some implementations of the current subject matter, the input/output device 840 can provide input/output operations for a network device. For example, the input/output device 840 can include Ethernet ports or other networking ports to communicate with one or more wired and/or wireless networks (e.g., a local area network (LAN), a wide area network (WAN), a cellular network, the Internet, and/or the like).

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as in a processor cache or other random access memory associated with one or more physical processor cores.

To provide for interaction with a user, the subject matter described herein can be implemented on a computer having a display device, such as for example a cathode ray tube (CRT), a liquid crystal display (LCD), or an organic light-emitting diode (OLED) display monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. A method comprising:
receiving, by a user equipment, a configuration for a machine learning model, the configuration comprising a plurality of weights determined by a server during a first phase training of the machine learning model;
initiating, by the user equipment, a second phase of training of the machine learning model using local training data at the user equipment to personalize the machine learning model to a user of the user equipment without updating the plurality of weights of the machine learning model, wherein the local training data is applied to the machine learning model to generate at least a first reference embedding mapped to a label, wherein the first reference embedding and the label are stored in a dictionary at the user equipment;
in response to receiving a first unknown sample at the machine learning model, using, by the user equipment, the machine learning model to perform a first inference task by generating a first embedding that is used to query the dictionary to find at least the first reference embedding and the label that identifies the first unknown sample;
in response to a condition at the user equipment being satisfied, triggering, by the user equipment, a third phase of training of the machine learning model using at least the local training data at the user equipment to update the plurality of weights of the machine learning model and to further personalize the machine learning model to the user of the user equipment; and
in response to receiving a second unknown sample at the machine learning model, using, by the user equipment, the machine learning model with the updated weights to perform a second inference task by generating a second embedding to query the dictionary to find a second reference embedding and a corresponding label that identifies the second unknown sample.

2. The method of claim 1, wherein in response to the update of the plurality of weights of the machine learning model, the reference embeddings are updated, and/or wherein the receiving further comprises receiving an initial set of one or more reference embedding mapped to corresponding labels.

3. The method of claim 1, wherein the machine learning model receives inputs from different domains, wherein the different domains include at least one of audio samples, video samples, image samples, biometric samples, bioelectrical samples, electrocardiogram samples, electroencephalogram samples, and/or electromyogram samples.

4. The method of claim 1, wherein the dictionary comprises an associative memory contained in the user equipment, wherein the associative memory stores a plurality of reference embeddings, each of which is mapped to a label.

5. The method of claim 4, wherein the associative memory comprises a lookup table, content-addressable memory, and/or a hashing function implemented memory, and/or wherein the associative memory comprises a random access memory coupled to digital circuitry that searches the random access memory for a reference embedding.

6. The method of claim 1, wherein the dictionary is comprised in magnetoresistive memory using spin orbit torque and/or spin transfer torque.

7. The method of claim 1, wherein the first unknown sample and the second unknown sample comprise speech samples from at least one speaker, wherein the first unknown sample and the second unknown sample comprise image samples, and/or wherein the first unknown sample and the second unknown sample comprise video samples.

8. The method of claim 1, wherein the first unknown sample and the second unknown sample comprise biometric samples, wherein the biometric samples comprise an electrocardiogram sample, an electroencephalogram sample, and/or an electromyogram signals.

9. The method of claim 1, wherein the first reference embedding, the first embedding, and the second embedding each comprise a feature vector generated as an output of the machine learning model.

10. The method of claim 1, wherein the machine learning model comprises a neural network and/or a convolutional neural network.

11. The method of claim 1, wherein the machine learning model is trained using a triplet loss function and/or gradient descent.

12. The method of claim 1, wherein at least one layer of the machine learning model uses same weights when processing inputs from different domains.

13. A system comprising:
at least one processor; and
at least one memory including code which when executed by the at least one processor causes operations comprising:
receiving a configuration for a machine learning model, the configuration comprising a plurality of weights determined by a server during a first phase training of the machine learning model;
initiating, a second phase of training of the machine learning model using local training data at the system to personalize the machine learning model to a user of a user equipment without updating the plurality of weights of the machine learning model, wherein the local training data is applied to the machine learning model to generate at least a first reference embedding mapped to a label, wherein the first reference embedding and the label are stored in a dictionary at the system;
in response to receiving a first unknown sample at the machine learning model, using, by the system, the machine learning model to perform a first inference task by generating a first embedding that is used to query the dictionary to find at least the first reference embedding and the label that identifies the first unknown sample;
in response to a condition at the system being satisfied, triggering, by the system, a third phase of training of the machine learning model using at least the local training data at the system to update the plurality of weights of the machine learning model and to further personalize the machine learning model to the user of the system; and
in response to receiving a second unknown sample at the machine learning model, using, by the system, the machine learning model with the updated weights to perform a second inference task by generating a second embedding to query the dictionary to find a second reference embedding and a corresponding label that identifies the second unknown sample.

14. The system of claim 13, wherein in response to the update of the plurality of weights of the machine learning model, the reference embeddings are updated and/or wherein the receiving further comprises receiving an initial set of one or more reference embedding mapped to corresponding labels.

15. The system of claim 13, wherein the machine learning model receives inputs from different domains, wherein the different domains include at least one of audio samples, video samples, image samples, biometric samples, bioelectrical samples, electrocardiogram samples, electroencephalogram samples, and/or electromyogram samples.

16. The system of claim 13, wherein the dictionary comprises an associative memory contained in the system, wherein the associative memory stores a plurality of reference embeddings, each of which is mapped to a label.

17. The system of claim 16, wherein the associative memory comprises a lookup table, content-addressable memory, and/or a hashing function implemented memory, and/or wherein the associative memory comprises a random access memory coupled to digital circuitry that searches the random access memory for a reference embedding.

18. The system of claim 13, wherein the dictionary is comprised in magnetoresistive memory using spin orbit torque and/or spin transfer torque.

19. The system of claim 13, wherein the first unknown sample and the second unknown sample comprise speech samples from at least one speaker, wherein the first unknown sample and the second unknown sample comprise image samples, and/or wherein the first unknown sample and the second unknown sample comprise video samples.

20. The system of claim 13, wherein the first unknown sample and the second unknown sample comprise biometric samples, wherein the biometric samples comprise an electrocardiogram sample, an electroencephalogram sample, and/or an electromyogram signals.

21-28. (canceled)
